(19) United States
(12) Patent Application Publication
(10) Pub. No.: US 2026/0199720 A1
(43) Pub. Date: Jul. 16, 2026

(54) AERIAL FIREFIGHTING DRONE

(71) Applicant: Halo Mechatronics Ltd., Armstrong (CA)

(72) Inventor: Carl Johnson, Armstrong (CA)

(21) Appl. No.: 19/427,295

(22) Filed: Dec. 19, 2025

Related U.S. Application Data
(60) Provisional application No. 63/736,569, filed on Dec. 19, 2024.

(51) Int. Cl. A62C 3/02; B64U 10/20; B64U 10/25; B64U 30/26; B64U 30/297; B64U 40/10; B64U 40/20; B64U 60/50; B64U 101/47

(52) U.S. Cl. CPC A62C 3/0235; B64U 10/20; B64U 10/25; B64U 30/26; B64U 30/297; B64U 40/10; B64U 40/20; B64U 60/50; B64U 2101/47

(57) ABSTRACT

An aircraft and system and method for delivering a payload is disclosed wherein the aircraft comprises a fuselage having a compartment operable to contain a payload, at least one rotatable arm extending from the fuselage and at least one propeller located at a distal end of the rotatable arm movable between a horizontal and a vertical configuration. The method comprises rotating the at least one arm about a pivot on the fuselage from a vertical configuration. The system further includes a landing frame adapted to receive the aircraft thereon such that the aircraft has no included landing gear.

### CROSS REFERENCE TO RELATED APPLICATION

This application claims benefit of U.S. provisional Ser. No. 63/736,569 filed Dec. 19, 2024 entitled Aerial Firefighting Drone.

### BACKGROUND

### 1. Technical Field

This disclosure relates generally to aerial vehicles and in particular to a method and apparatus for delivering substances to a location with an unmanned aerial vehicle.

### 2. Description of Related Art

Fire fighting is a dangerous task. In addition to the obvious risks of burns and smoke inhalation, the professionals engaged in this task may be required to work long hours resulting in exhaustion, fatigue and the associated risks resulting from such long hours. Compounding these difficulties is the fact that many wild fires, or forest fires, are in remote locations making access time consuming and difficult.

Aerial fire fighting has long been a known method of attacking wildfires in remote or difficult to reach locations or quicker than ground personnel are able to be on site. In particular, the most commonly used methods of providing aerial fire fighting is to utilize helicopter or fixed wing aircraft for dropping water and/or fire retardant on and around the fire location. Disadvantageously, such existing aircraft are manned or piloted aircraft requiring the services of at least one onboard pilot. The use of a pilot adds additional complexities for their safe operation as many jurisdictions have regulated limits on the length of time a pilot can work, the times of day in which a pilot and their aircraft can safely operate. Additionally, it will be appreciated that pilots qualified to operate their aircraft in such challenging conditions as near a wildfire are relatively few due to the extensive training required.

The use of each of a fixed wing aircraft or a helicopter each have advantages and disadvantages. In particular, fixed wing aircraft may be limited in the fires they are able to access due to the maneuverability of the aircraft in tight spaces, or limited availability of nearby suitable runways. Similarly, rotary aircraft, such as helicopters may have a reduced payload as compared to fixed wing aircraft and may therefore be unable to deliver the same quantity of water to the fire. It will be appreciated that both conventional fixed wing and fixed helicopters disadvantageously create a risk to the pilot and both are only available in limited quantities due to observation and control limitations by pilot and aircraft.

### SUMMARY OF THE DISCLOSURE

According to a first embodiment of the present disclosure is an aircraft comprising a fuselage having a compartment operable to contain a payload, at least one rotatable arm extending from the fuselage and at least one propeller located at a distal end of the rotatable arm movable between a horizontal and a vertical configuration.

The fuselage may include at least one pair of wings extending therefrom. The pair of wings may be free of any movable or control surfaces. Each rotatable arm may include a propeller at a distal end thereof.

The at least one rotatable arm may comprise two pairs of rotatable arms, a first pair being located above the wings in the horizontal configuration and a second pair being located below the wings in the horizontal configuration. The propellers of the first pair of arms may be located entirely above the wings in the horizontal configuration. The propellers of the second pair of arms may be located entirely below the wings in the horizontal configuration.

The least one of the rotatable arms may be pivotably mountable to the fuselage. The fuselage mounted rotatable arm may rotate along a plane having an angle between vertical and the horizontal configurations. The least one of the rotatable arms may be pivotably mountable to the wing. The wing mounted rotatable arm may rotate along a vertical plane parallel to a forward direction of the aircraft.

Each of the propellers may have an equal size. The aircraft may include a control aircraft for controlling flight. The control system may be operable to modify the thrust provided by each propeller, the angle of each propulsion arm, and the angle of the motor mount at the end of each propulsion arm.

According to a further embodiment of the present disclosure is a method of transitioning an aircraft from vertical to horizontal flight comprising providing a fuselage having a compartment operable to contain a payload, the fuselage having at least one rotatable arm extending from the fuselage with a propeller located at a distal end thereof and rotating the at least one arm about a pivot on the fuselage from a vertical configuration.

According to a further embodiment of the present disclosure is a system for delivering a payload using an aircraft comprising an aircraft comprising a fuselage having a compartment operable to contain a payload, at least one rotatable arm extending from the fuselage and at least one propeller located at a distal end of the rotatable arm movable between a horizontal and a vertical configuration. The system further comprises a landing frame adapted to receive the aircraft thereon such that the aircraft has no included landing gear.

The landing frame may include connectors for receiving cooperating connectors on the aircraft thereon in mating engagement. The connectors may be configured to transmit electricity from the frame to the aircraft. The connectors may be configured to transmit a fluid to the aircraft. The frame may include a coupling for interconnecting a plurality of frames together.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a perspective view of an unmanned aerial vehicle according to a first embodiment of the present disclosure with the propellers configured to a horizontal orientation for horizontal flight.

FIG. 2 is a perspective view of the unmanned aerial vehicle of FIG. 1 with the propellers configured to a vertical orientation for vertical or transition flight.

FIG. 3 is a top plan view of the unmanned aerial vehicle of FIG. 1.

FIG. 4 is a perspective view of the fuselage of the unmanned aerial vehicle of FIG. 1.

FIG. 5 is a bottom view of the fuselage of the unmanned aerial vehicle of FIG. 1.

FIG. 6 is a front view of the fuselage of the unmanned aerial vehicle of FIG. 1.

FIG. 7 is a front view of the fuselage of the unmanned aerial vehicle of FIG. 1 with the cargo doors open.

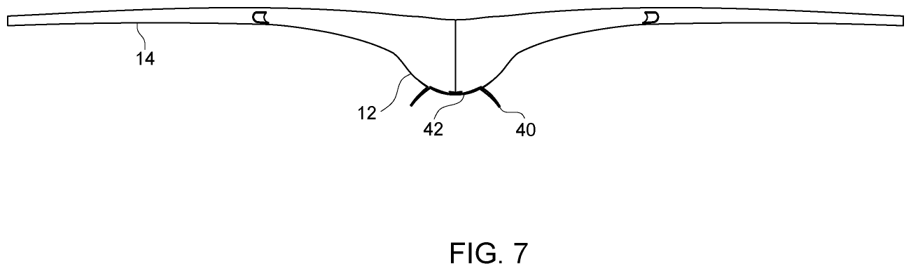

FIG. 8 is a bottom perspective view of the unmanned aerial vehicle of FIG. 1 with a cooperating landing frame.

FIG. 9 is a perspective view of the landing frame of FIG. 8.

FIG. 10 is a front view of the landing frame of FIG. 8.

FIG. 11 is a top plan view of a plurality of landing frames with associated unmanned aerial vehicles thereon, interconnected together.

FIG. 12 is a control diagram for the unmanned aerial vehicle of FIG. 1.

### DETAILED DESCRIPTION

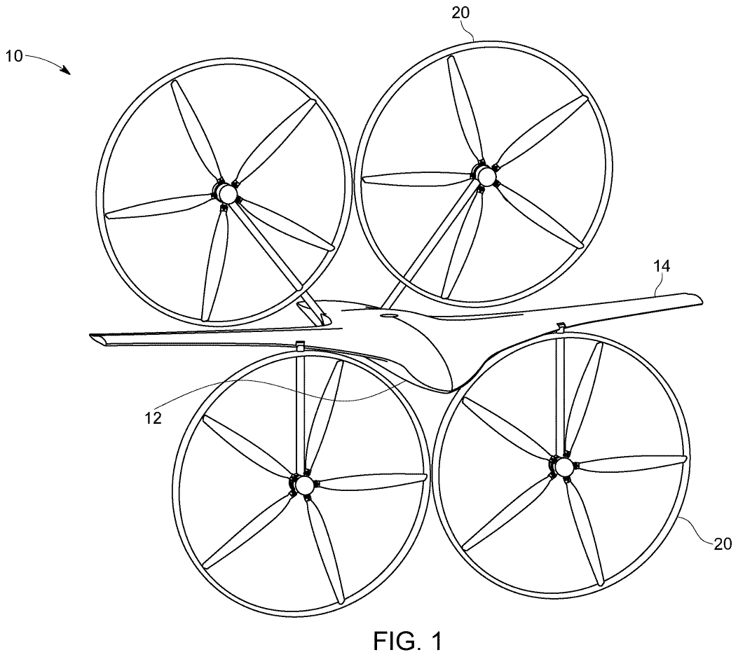

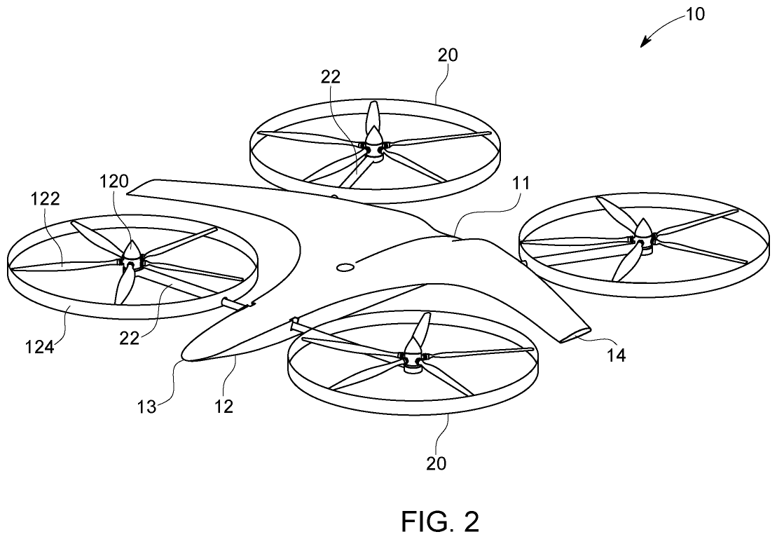

Referring to FIGS. 1 and 2, an aircraft for delivering water and fire retardant to a fire is illustrated generally at 10. The aircraft 10 comprises an airframe having a central fuselage 12 and a pair of wings 14 extending therefrom. The aircraft includes rotatable arms 22 extending therefrom with propeller assemblies including propellers 20 on the ends thereof. As illustrated in FIG. 1, the arms are rotatable to a horizontal configuration for forward flight wherein the propellers provide thrust to move the aircraft forward 10 such that the wings and fuselage provide the required lifting force. As illustrated in FIG. 2, the rotatable arms 22 may also be rotated to a vertical configuration (with the propellers rotating about a substantially vertical axis) for vertical flight, such as during take off and landing, while refilling or dropping water or as needed depending on the selecting flight path. Dropping of water may also occur during forward (horizontal) flight. It will also be appreciated that the rotatable arms 22 may also be rotated to configurations at other angles between vertical and horizontal for lower speed or flight transitioning between vertical and horizontal.

As utilized herein the term vertical configuration when used in reference to the propellers or thrust will refer to the vertical orientation of the propellers as rotating about a substantially vertical axis such that the propeller blades extend along and rotate along a substantially horizontal plane. Such configuration may be utilized for vertical flight or low or medium speed horizontal flight as well as combinations thereof. The term horizontal configuration shall refer to the propellers in a configuration in which the axis of rotation is substantially horizontal such that blades rotate along a plane that is substantially vertical. Such orientation may be used for substantially horizontal or traditional flight for a fixed wing aircraft.

The fuselage extends between leading and trailing edges, 11 and 13, respectively. The wings 14 are located proximate to the leading edge 11 of the airframe and do not include any movable surfaces such as ailerons, flaps or the like as all flight adjustment is provided by the propellers 20 and an associated control system as will be further set out below. In some embodiments, the water portion of the fuselage does not reach the trailing or leading edge. avionics bay will likely be near leading edge, the trailing edge will be vacant/structural as body tapers down significantly near trailing edge. The fuselage and wings may be formed of any known techniques and materials. In particular, it has been found the forming the fuselage and wings of aluminium has been advantageous for cost and manufacturing considerations.

As set out above, the propellers 20 are located on the ends of rotatable arms 22 with the drive motors 102 in the hubs of the propellers 20. As illustrated in FIGS. 1 and 2, two of rotatable arms 22 are rotatably connected to the wings 14 to extend forward thereof. In particular, in such arrangements, the connection point for the rotatable arms 22 to the airframe 12 may be positioned far enough out on the wing so that the rotatable arm is permitted to rotate along a horizontal plane.

Furthermore, as illustrated, two of the rotatable arms 22 are rotatably connected to the fuselage 12 behind the wings 14. In such connections, it will be appreciated that an order to space the propellers 20 far enough apart, the rotatable arms 22 have a connection point closer together and therefor the rotatable arms 22 are rotated along planes at an angle between horizontal and vertical. The angle of such plane will be selected depending on the size of the aircraft, vehicle velocity and payload requirement.

As illustrated in FIG. 2 the propellers are orientable to the vertical configuration to operate as a vertical take-off and landing aircraft. As illustrated in FIG. 1, the propellers 20 are rotatable by the arms 22 to be substantially vertical for flight using the wings. In particular, as illustrated in FIG. 1, the front propellers are rotated down below the wings and the rear propellers are rotated up to be above and behind the wings. In particular as shown in FIG. 1, the sweep (or path of air entering or leaving) of the propellers does not intersect the airframe and in particular the wing. In such manner the propeller operation does not limit the effect of the lift provided by the wings during horizontal flight.

In a vertical configuration, each of the propellers is spaced around the aircraft 10 so as to support the center of gravity of the aircraft. It will be appreciated that such specific location and placement will be selected based on the weight and shape of the airframe. Furthermore, as shown in FIG. 1, the forward most propellers may be rotatable to a position below the wings in a horizontal configuration and the rearmost propellers may be rotatable to a position above the wings so as to reduce interference between the airfoil and the outflowing air from the front propellers. The specific locations and rotation points for each propeller may be selected to balance the lift as well as propulsion required from each propeller. Furthermore, as illustrated, each of the propellers may be of an equal size and type so as to be operable to provide equal thrust or lift although non-matching propellers may also be utilized depending on location and thrust type.

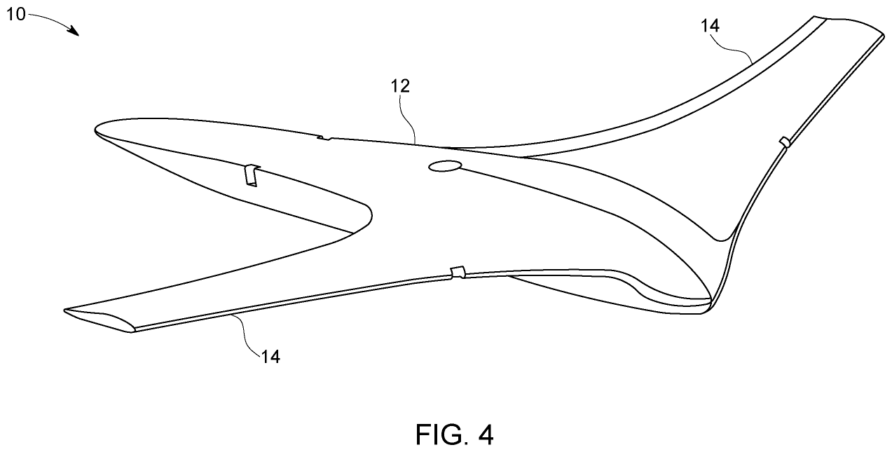

FIG. 4 shows the airframe in isolation wherein the wings and fuselage may comprise a combined lifting body. In particular, as illustrated in FIG. 4, the fuselage 12 of the aircraft 10 may be shaped so as to provide lift to the aircraft during forward flight. Such shapes are known in the art.

As set out above, the fuselage is devoid of aerodynamic control surfaces, tail fins, or landing gear. The fuselage includes a payload compartment 42 s will be further set out below to contain a payload which in some embodiments may comprise water storage. The remainder of the interior of the fuselage may contain batteries 108, the controller 100 motors and a network interface 110 in positions selected to maximize the size of the payload compartment. Optionally, the batteries 108 may form an integral structural component to the wings.

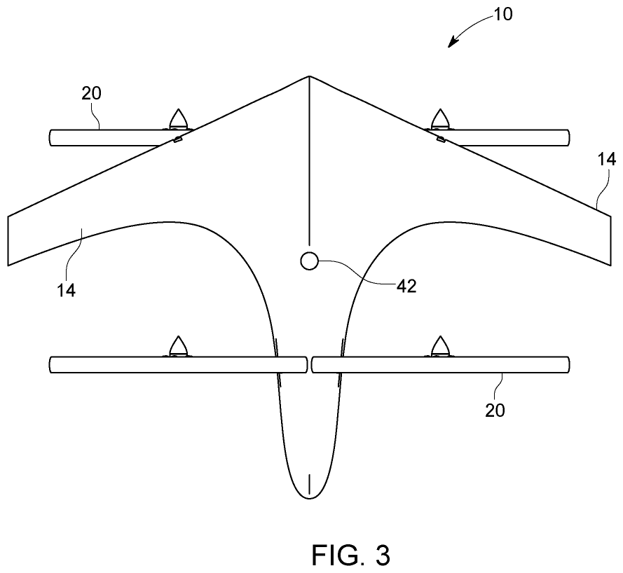

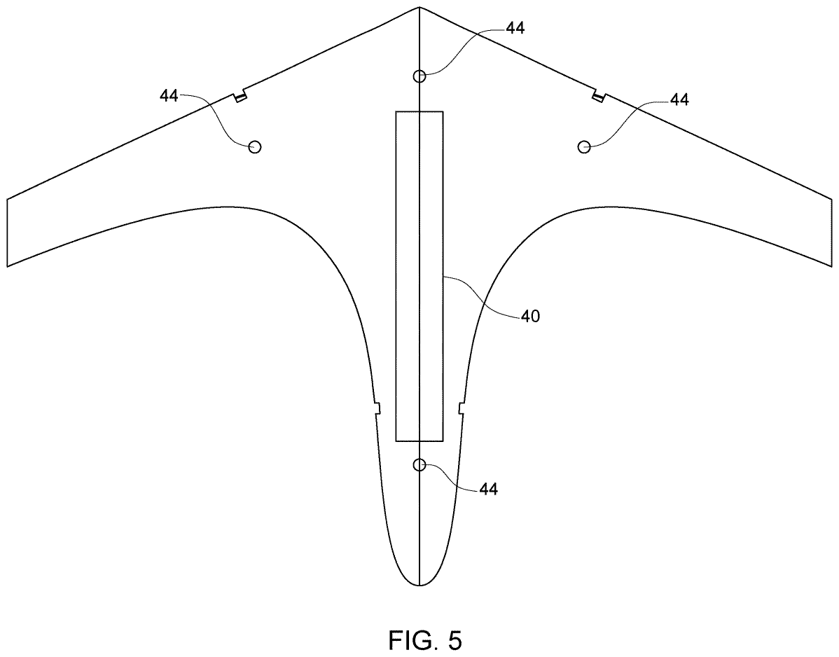

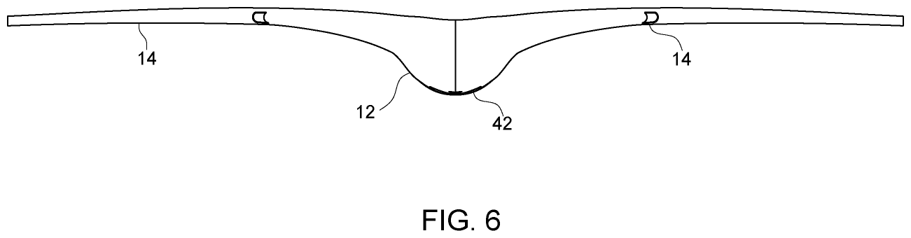

As shown in the bottom view of FIG. 5, the fuselage 12 may include doors 40 opening to a compartment 42 operable to contain a quantity of water. In particular, the aircraft 10 may be positioned over a body of water and the doors 40 opened so as to permit a quantity of water to enter the compartment The doors 40 may open when the bottom of the fuselage is submerged to fill the compartment. The doors 40 may also open during flight to facilitate payload deployment. Alternatively the compartment may be filled by a water fill port as set out below. The compartment may also include a vent 42 shown in FIG. 3 to release air from the compartment during filing or to assist water drops therefrom. FIG. 6 shows the front view of the airframe with the doors closed.

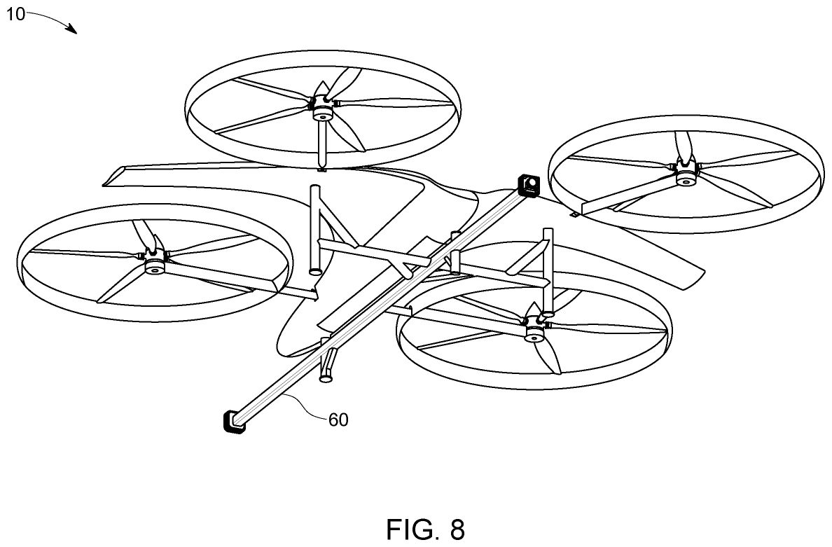

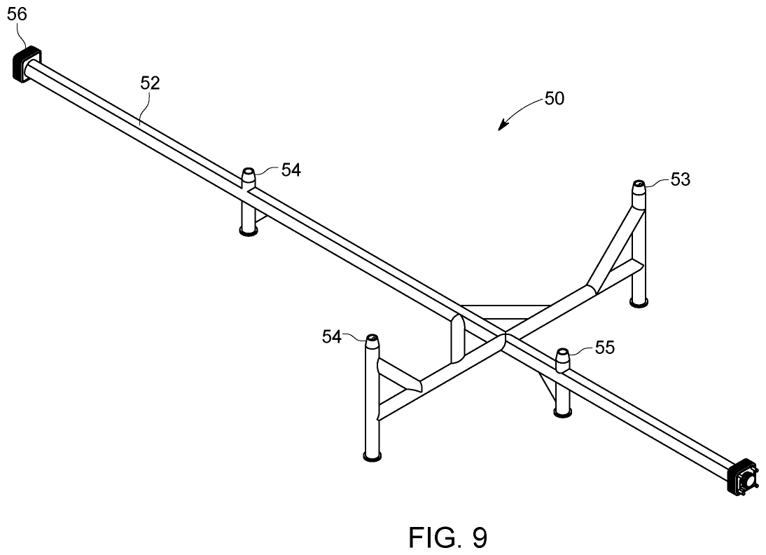

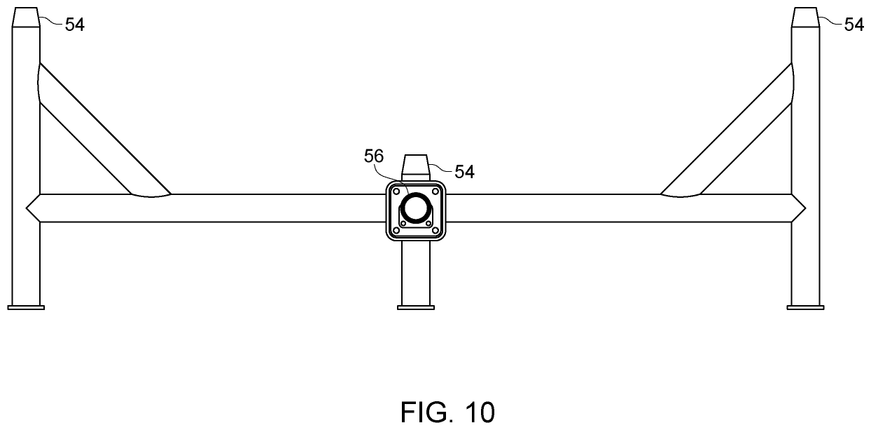

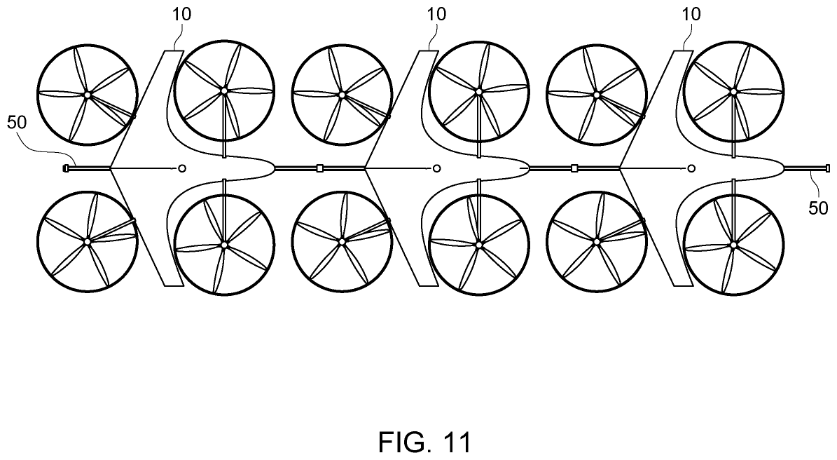

Turning to FIGS. 8 through 11, the system may include a landing frame 50. The landing frame comprises a base frame 52 with a plurality of connection ports 54 extending therefrom. The connection ports are positioned to interface with corresponding ports 44 in the underside of the airframe as shown in FIG. 5. Some of the ports may be configured to be electrical connectors 53 to transmit electricity from the landing frame to the aircraft 10 while others may be configured as water connectors 55 to introduce water or fire suppression liquids thereto for storage in the compartment 42. The connection ports 54 are also configured to support the aircraft 10 during such transfers. The landing frame may include end connectors 56 for interlinking a plurality of landing frame 50 to each other to support multiple aircraft 10 as shown in FIG. 11. The end connectors 56 may be configured to transmit, electricity, water or both. It will also be appreciated that the electrical connectors 53 may also be configured to transmit information, including without limitation, maps, operating system upgrades and instructions from an external control system (not shown) and the controller 100. It will also be appreciated that separate high and low voltage connectors may be utilized for power and data transmission, respectively.

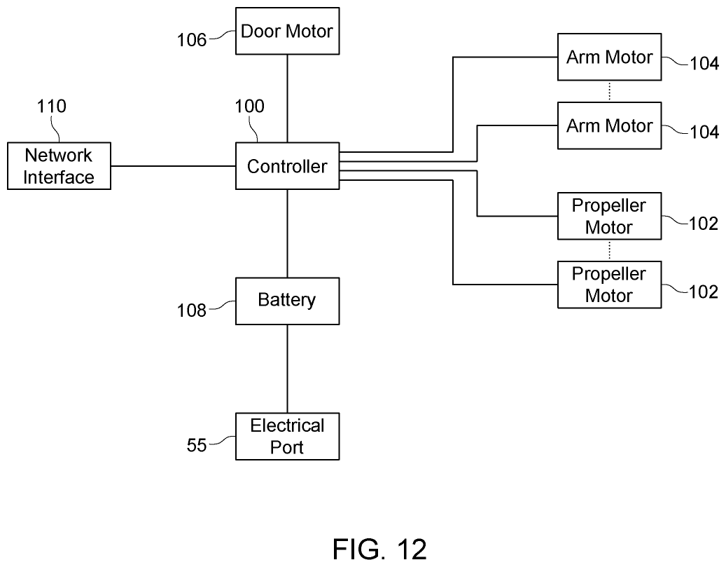

Turning now to FIG. 12, the aircraft may include a controller 100 for controlling the operation, including flight, filling and dumping of water as is commonly known for unmanned aerial vehicles. In particular, the controller 100 may be interfaced with each of the propeller motors 102 so as to be operable to independently control each motor and arm motors 104 wherein the arm motors are operable to rotate each rotatable arm 22 and each propeller motor 102 is operable to drive or operate a propeller 20. In particular, the controller will control motor thrust, propulsion arm angle, motor angle and payload door motor/angle. Furthermore it will be appreciated that motor thrust, propulsion arm angle, motor angle may all be controlled individually. Ie. each motor may have different motor thrust, each propulsion arm may be at a different angle, and each motor may be at a different angle. Essentially, for control there are three outputs per propulsion unit (thrust, propulsion arm angle, and motor angle). Accordingly, the controller 100 (in cooperation with any sensors, including without limitation, global positioning, global navigation satellite system, inertial navigation system, air speed sensors, proximity sensors, optical sensors, infrared sensors or the like an) is configured to control and stabilize the flight path of the aircraft 10. The controller may also be adapted to control the operation of a door motor 106 positioned to control the opening of the compartment doors 40 as set out above. Optionally, the controller 100 and network interface 102 may be configured to permit the aircraft 100 to operate autonomously and optionally deployed in swarms of multiple aircraft 100. According to some embodiments, each fan assembly may rotate about the arms 22 along a coaxial axis aligned with the arm so as to provide two degrees of freedom of the alignment of the fan.

Although the propellers as illustrated in the attached drawings and described above, are shown as ducted propellers, it will be appreciated that other propellers or propulsion devices may also be utilized, such as, by way of non-limiting example, un ducted propellers, jet engines, turbo fans, turbo prop engines or any other propulsion means as are known for use in aircraft. It will be appreciated that the aircraft may optionally include an on-board combustion (gas/diesel/etc.) generator which is used to charge the battery pack during flight, extending range.

While the present description is directed to the use of the present apparatus for fighting fires, it will be appreciated that the apparatus may also be adapted for use in other purposes. In particular, the apparatus may also be utilized for carrying other fluids, solid particles, powders, and objects. By way of non-limiting example, such apparatus may therefore be useful in delivering packages and objects, watering and spraying crops, loading grains, minerals and other powders onto ships of other vessels or moving people.

While specific embodiments of the disclosure have been described and illustrated, such embodiments should be considered illustrative only and not as limiting the invention as construed in accordance with the accompanying claims.

What is claimed is:

1. An aircraft comprising:
a fuselage having a compartment operable to contain a payload;
at least one rotatable arm extending from the fuselage; and
at least one propeller located at a distal end of the rotatable arm movable between a horizontal and a vertical configuration.

2. The aircraft of claim 1 wherein the fuselage includes at least one pair of wings extending therefrom.

3. The aircraft of claim 2 wherein the pair of wings are free of any movable or control surfaces.

4. The aircraft of claim 1 wherein each rotatable arm includes a propeller at a distal end thereof.

5. The aircraft of claim 4 wherein the at least one rotatable arm comprises two pairs of rotatable arms, a first pair being located above the wings in the horizontal configuration and a second pair being located below the wings in the horizontal configuration.

6. The aircraft of claim 5 wherein the propellers of the first pair of arms are located entirely above the wings in the horizontal configuration.

7. The aircraft of claim 5 wherein the propellers of the second pair of arms are located entirely below the wings in the horizontal configuration.

8. The aircraft of claim 1 wherein the least one of the rotatable arms is pivotably mountable to the fuselage.

9. The aircraft of claim 8 wherein the fuselage mounted rotatable arm rotate along a plane having an angle between vertical and the horizontal configurations.

10. The aircraft of claim 8 wherein the least one of the rotatable arms are pivotably mountable to the wing.

11. The aircraft of claim 10 wherein the wing mounted rotatable arm rotate along a vertical plane parallel to a forward direction of the aircraft.

12. The aircraft of claim 1 wherein each of the propellers have an equal size.

13. The aircraft of claim _ wherein the aircraft includes a control aircraft for controlling flight.

14. The aircraft of claim _ wherein the control system is operable to modify the thrust provided by each propeller, the angle of each propulsion arm, and the angle of the motor mount at the end of each propulsion arm.

15. A method of transitioning an aircraft from vertical to horizontal flight comprising;
providing a fuselage having a compartment operable to contain a payload, the fuselage having at least one rotatable arm extending from the fuselage with a propeller located at a distal end thereof; and
rotating the at least one arm about a pivot on the fuselage from a vertical configuration.

16. A system for delivering a payload using an aircraft comprising an aircraft comprising:
a fuselage having a compartment operable to contain a payload;
at least one rotatable arm extending from the fuselage: and at least one propeller located at a distal end of the rotatable arm movable between a horizontal and a vertical configuration; and
a landing frame adapted to receive the aircraft thereon such that the aircraft has no included landing gear.

17. The system of claim 16 wherein the landing frame includes connectors for receiving cooperating connectors on the aircraft thereon in mating engagement.

18. The system of claim 17 wherein the connectors are configured to transmit electricity from the frame to the aircraft.

19. The system of claim 17 wherein the connectors are configured to transmit a fluid to the aircraft.

20. The system of claim 16 wherein the frame includes a coupling for interconnecting a plurality of frames together.
